(19) United States
(12) Patent Application Publication
(10) Pub. No.: US 2021/0323836 A1
(43) Pub. Date: Oct. 21, 2021

(54) WATER DISPENSING AND FILTRATION SYSTEM

(71) Applicant: Arrow Plastic Manufacturing Co., Elk Grove Village, IL (US)

(72) Inventors: David Maas, Wheaton, IL (US); Robert Kleckauskas, St. Charles, IL (US); Robert Elefante, New Vernon, NJ (US); Rita Sifuentes, Melrose Park, IL (US)

(21) Appl. No.: 17/233,183

(22) Filed: Apr. 16, 2021

Related U.S. Application Data
(60) Provisional application No. 63/011,035, filed on Apr. 16, 2020.

(51) Int. Cl. C02F 1/00; B01D 29/11; B01D 39/20; B67D 3/00

(52) U.S. Cl. CPC C02F 1/003; B01D 29/114; C02F 2307/10; B67D 3/0058; B01D 39/2055

(57) ABSTRACT

A dispensing container facilitates convenient chilling and dispensing of water, with a filtration arrangement provided to promote water purity. The system includes a generally cylindrical filter assembly positionable within a liquid container, so that the filter assembly is generally submerged in the water within the container. The filter assembly can be operably connected to a liquid spigot, so that when the spigot is opened, liquid within the container flows through the filter assembly and out of the container, through the opened liquid spigot. Convenient use by consumers is promoted by the provision of a filter protector, comprising a selectively removable, shrink-wrap sleeve surrounding the filter assembly. The shrink-wrap sleeve is positioned on the filter assembly to protect the assembly prior to removal of the shrink-wrap sleeve. A removable tape element is provided to temporarily connect the filter assembly to the spigot prior to use.

### CROSS-REFERENCE TO RELATED APPLICATIONS

This application claims priority of Provisional Ser. No. 63/011,035, filed Apr. 16, 2020, the disclosure of which is hereby incorporated by reference in its entirety.

### FEDERALLY SPONSORED RESEARCH OR DEVELOPMENT

Not Applicable.

### MICROFICHE/COPYRIGHT REFERENCE

Not Applicable.

### FIELD OF THE INVENTION

The present invention relates generally to dispensing containers, and more particularly to dispensing container which facilitates convenient chilling and dispensing of water, with a filtration arrangement provided to promote water purity. The system includes improved packaging to promote efficient shipment and storage, and convenient use by consumers.

### BACKGROUND OF THE INVENTION

Arrangements which permit storage and dispensing of liquids from with a refrigerator or the like have become increasingly popular as the health benefits associated with improved personal hydration are becoming more widely appreciated. Such arrangements are environmentally beneficial since they avoid the use of disposable containers, while still permitting users to enjoy chilled beverages.

Because of the inevitable variations in the quality of tap water supplied to a home or workplace, many users prefer to consume water which has been filtered to limit and remove impurities that can adversely affect water taste and other properties.

The present invention is directed to a water dispensing and filtration system which permits water to be conveniently stored, and chilled if desired, for dispensing and consumption, with the system including an integral filtration arrangement which automatically filters the water as it is dispensed.

### SUMMARY OF THE INVENTION

In accordance the present invention, an improved water dispensing and filtration system promotes convenient chilling and dispensing of water, such as by positioning the arrangement on a refrigerator shelf or the like. Convenient use by consumers is facilitated by improved packaging with desirably protects and covers a filter assembly of the system prior to use.

In accordance with the present invention, the present water dispensing and filtration system comprises a liquid container defining an upper filling opening, and a lower dispensing opening. The system further includes a selectively openable liquid spigot, configured for fitment to the lower dispensing opening of the liquid container. The spigot can be fitted to the container by a threaded connection, bayonet fitting, snap fitting, or other arrangement. Operation of the spigot by manipulation of its valve member acts to dispense water, by gravity, from within the container.

The system includes a generally cylindrical filter assembly positionable within the liquid container, so that the filter assembly is generally submerged in the water within the container. The filter assembly can be operably connected to the liquid spigot, so that when the spigot is opened, liquid within the container flows through the filter assembly and out of the container, through the opened liquid spigot.

Convenient use by consumers is promoted by the provision of a filter protector, comprising a selectively removable, shrink-wrap sleeve surrounding the filter assembly. The shrink-wrap sleeve is positioned on the filter assembly to protect the assembly prior to removal of the shrink-wrap sleeve. A removable tape element is provided to temporarily connect the filter assembly to the spigot prior to use.

By this arrangement, the present system can be shipped to consumers with the filter assembly connected to the spigot, and with filter protector and tape element in place. The spigot can be fitted to the container such that the filter assembly, with its protective cover, are positioned with the container.

For use, the spigot can be removed so that the tape element and the shrink-wrap filter protector can be removed from the filter assembly, and the filter assembly reconnected to the spigot. The filter assembly, connected to the spigot, can then be inserted into the liquid container through the lower dispensing opening, and the liquid spigot can be fitted to the dispensing opening. The container can then be filled through the upper filling opening. Filtered water can then be easily dispensed from within the container by manipulation of the spigot.

Use of an activated charcoal filter media, positioned within the filter assembly, is presently preferred. Use of the shrink-wrap filter protector desirably acts to maintain the filter media in fresh condition for use. Replacement filter assemblies can be refitted as may be required.

### BRIEF DESCRIPTIONS OF THE DRAWINGS

The invention will be more easily understood by a detailed explanation of the invention including drawings. Accordingly, drawings, which are particularly suited for explaining the inventions, are attached herewith; however, it should be understood that such drawings are for descriptive purposes only and as thus are not necessarily to scale beyond the measurements provided. The drawings are briefly described as follows:

FIG. 1 is a perspective view of the water dispensing and filtration system of the present invention;

FIG. 2 is a relatively enlarged perspective view of the present system.

FIG. 3 end elevational view of the present system;

FIG. 4 side elevational view of the present system;

FIG. 5 shows a filter assembly and liquid spigot of the present system; and

FIG. 6 is an exploded view of the filter assembly and spigot of the present system.

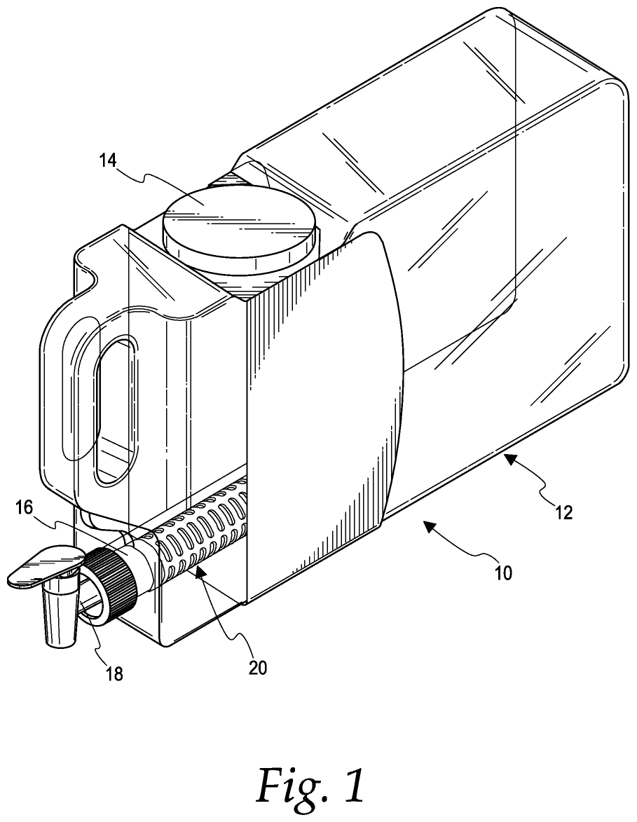

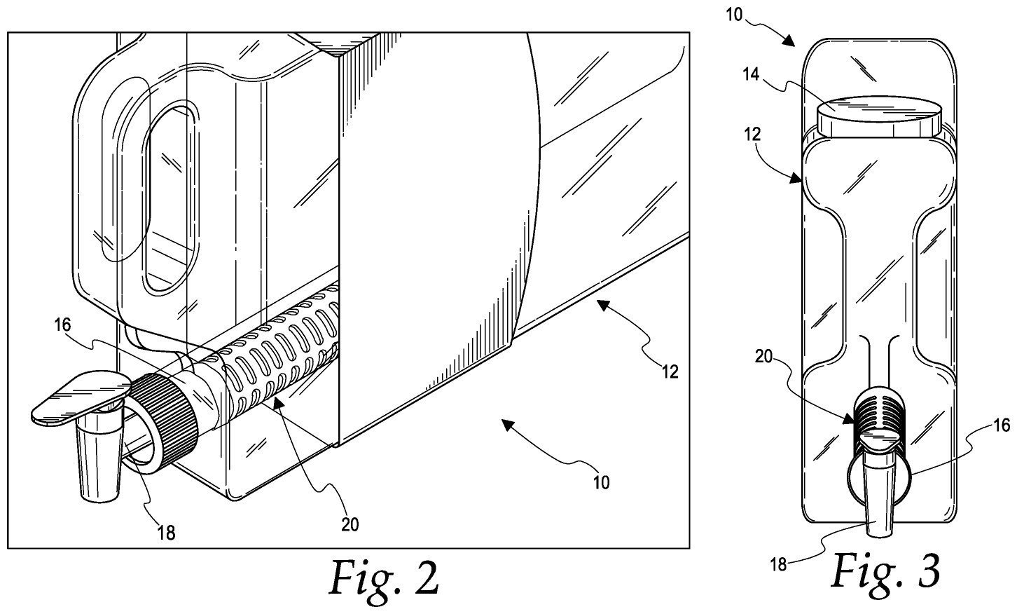

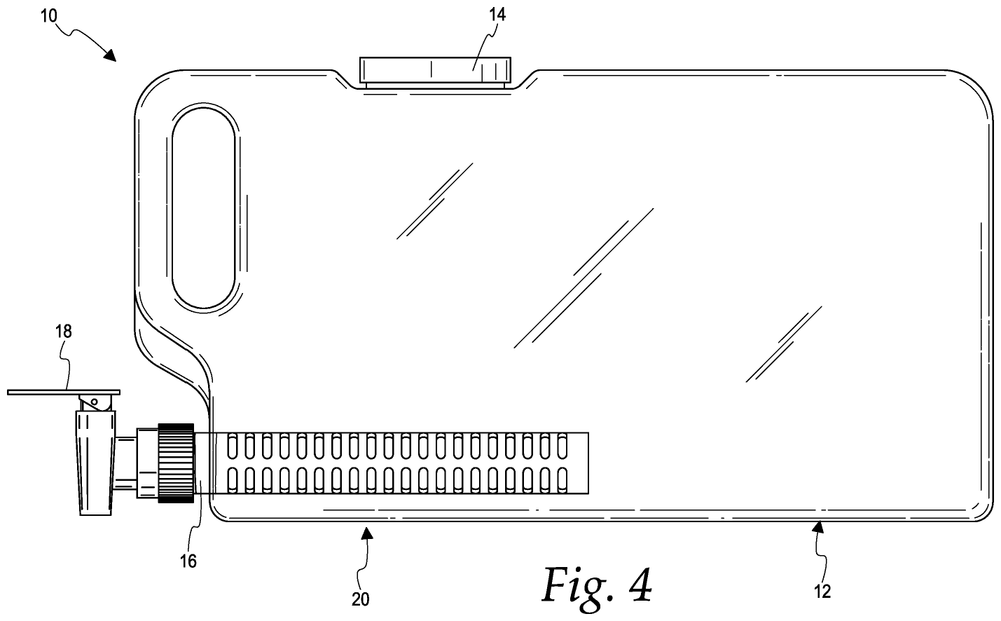

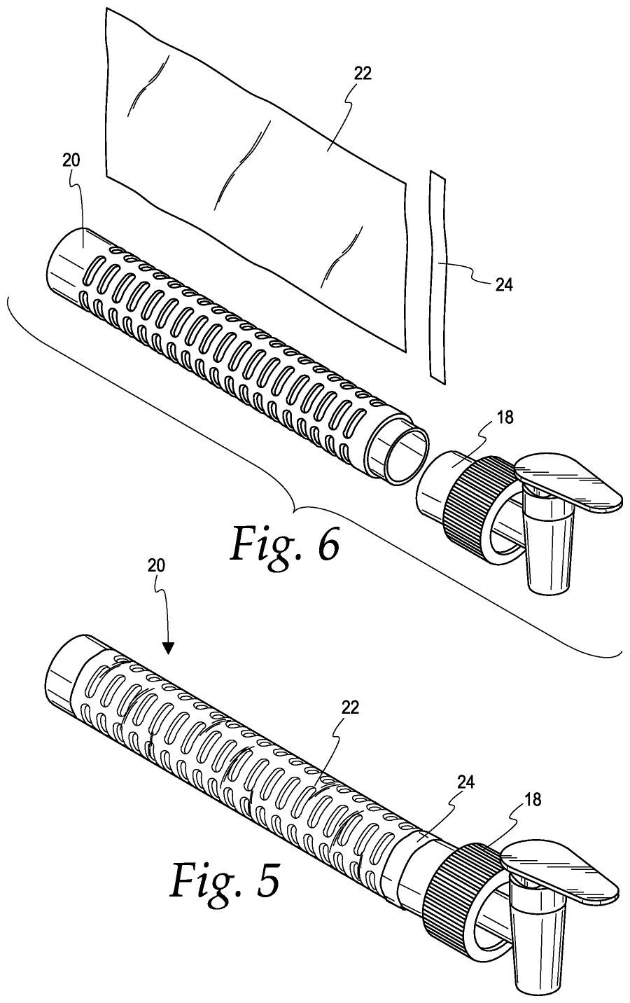

### DETAILED DESCRIPTION OF THE INVENTION

In accordance the present invention, an improved water dispensing and filtration system 10 promotes convenient chilling and dispensing of water, such as by positioning the arrangement on a refrigerator shelf or the like. Convenient use by consumers is facilitated by improved packaging with desirably protects and covers a filter assembly of the system prior to use.

In accordance with the present invention, the present water dispensing and filtration system 10 comprises a liquid container 12 defining an upper filling opening 14 , and a lower dispensing opening 16. The system 10 further includes a selectively openable liquid spigot 18, configured for fitment to the lower dispensing opening 16 of the liquid container 12. The spigot 18 can be fitted to the container 12 by a threaded connection, bayonet fitting, snap fitting, or other arrangement. Operation of the spigot by manipulation of its valve member acts to dispense water, by gravity, from within the container. It will be understood that in some applications of the present invention, the spigot 18 may take other forms, such as a push-to-open flexible membrane actuated tap, or other functionally equivalent mechanism to allow a user to selectively control flow out of the lower dispensing opening 16.

The system 10 includes a generally cylindrical filter assembly 20 positionable within the liquid container 12, so that the filter assembly 20 is generally submerged in the water within the container 12. The filter assembly 20 can be operably connected to the liquid spigot 18, so that when the spigot 18 is opened, liquid within the container flows through the filter assembly 20 and out of the container 12, through the opened liquid spigot 18.

Convenient use by consumers is promoted by the provision of a filter protector 22 (best seen in FIG. 20), comprising a selectively removable, shrink-wrap sleeve surrounding the filter assembly 20. The shrink-wrap sleeve 22 is positioned on the filter assembly 20 to protect the assembly prior to removal of the shrink-wrap sleeve 22. A removable tape element 24 (best seen in FIG. 6) is provided to temporarily connect the filter assembly 20 to the spigot 18 prior to use.

By this arrangement, the present system 10 can be shipped to consumers with the filter assembly 20 connected to the spigot 18, and with filter protector 22 and tape element 24 in place. The spigot 18 can be fitted to the container 12 such that the filter assembly 20, with its protective cover 22, are positioned with the container 12.

For use, the spigot 18 can be removed so that the tape element 24 and the shrink-wrap filter protector 22 can be removed from the filter assembly 20, and the filter assembly 20 reconnected to the spigot 18. The filter assembly 20, connected to the spigot 18, can then be inserted into the liquid container 12 through the lower dispensing opening 16, and the liquid spigot 18 can be fitted to the dispensing opening 16. The container 12 can then be filled through the upper filling opening 14. Filtered water can then be easily dispensed from within the container 12 by manipulation of the spigot 18.

Use of an activated charcoal filter media, positioned within the filter assembly 20, is presently preferred. Use of the shrink-wrap filter protector 22 desirably acts to maintain the filter media in fresh condition for use. Replacement filter assemblies can be refitted as may be required.

From the foregoing, it will be observed that numerous modifications and variations can be effected without departing from the true spirit and scope of the present invention. The present disclosure is intended to cover, by the appended claims, all such modifications that fall within the scope of the claims.

Other features and advantages of the present invention will become readily apparent from the accompanying illustration and appended claims.

What is claimed is:

1. A water dispensing and filtration system comprising:
a liquid container defining an upper filling opening, and a lower dispensing opening;
a selectively openable liquid spigot configured for fitment to said lower dispensing opening of said liquid container;
a filter assembly positionable within said liquid container, said filter assembly being operably connectable to said liquid spigot so that liquid within said liquid container flows through said filter assembly and out of said container through said liquid spigot; and
a filter protector comprising a selectively removable, shrink-wrap sleeve surrounding said filter assembly, said shrink-wrap sleeve being positioned on said filter assembly to protect said assembly prior to removal of said shrink-wrap sleeve, so that said filter assembly can be joined to said liquid spigot to permit said filter assembly to be inserted into said liquid container through said dispensing opening, and said liquid spigot can be fitted to said lower, dispensing opening.

2. The water dispensing and filtration system in accordance with claim 1, wherein said filter assembly comprises activated charcoal as a filter media.

3. The water dispensing and filtration system in accordance with claim 1, wherein said system further comprises an elongate tape element connecting said filter assembly to said liquid spigot.

4. An assembly for use with a water dispensing and filtration system, said assembly comprising:
a selectively openable liquid spigot configured for fitment to a dispensing opening of a liquid container; and
a filter assembly positionable within said dispensing opening of said liquid container, said filter assembly being operably connectable to said liquid spigot so that liquid within said liquid container flows through said filter assembly and out of said container through said liquid spigot; and
a filter protector comprising a selectively removable, shrink-wrap sleeve surrounding said filter assembly, said shrink-wrap sleeve being positioned on said filter assembly to protect said assembly prior to removal of said shrink-wrap sleeve, so that said filter assembly can be joined to said liquid spigot to permit said filter assembly to be inserted into said liquid container through said dispensing opening, and said liquid spigot can be fitted to said lower, dispensing opening.

5. The assembly in accordance with claim 4, wherein said assembly further comprises an elongate tape element connecting said filter assembly to said liquid spigot.
